(19) United States
(12) Patent Application Publication
(10) Pub. No.: US 2014/0222370 A1
(43) Pub. Date: Aug. 7, 2014

(54) RAPID DENSE POINT CLOUD IMAGING USING PROBABILISTIC VOXEL MAPS

(71) Applicants: Robert Manzke, Bonebuttel (DE); Bharat Ramachandran, Morganville, NJ (US); Raymond Chan, San Diego, CA (US)

(72) Inventors: Robert Manzke, Bonebuttel (DE); Bharat Ramachandran, Morganville, NJ (US); Raymond Chan, San Diego, CA (US)

(21) Appl. No.: 14/240,434

(22) PCT Filed: Aug. 28, 2012
(86) PCT No.: PCT/IB2012/054409

§ 371 Date: Feb. 24, 2014

Related U.S. Application Data
(60) Provisional application No. 61/530,459, filed on Sep. 2, 2011.

(51) Int. Cl. G01B 11/14

(52) U.S. Cl. CPC G01B 11/14
USPC 702/150; 356/32

(57) ABSTRACT

A system, device and method include a sensing enabled device (104) having at least one optical fiber (126) configured to sense induced strain. An interpretation module (115) is configured to receive signals from the at least one optical fiber interacting with a volume and to interpret the signals to determine positions visited by the at least one optical fiber within the volume. A storage device (116) is configured to store a history of the positions visited in the volume.

This disclosure relates to mapping images and more particularly to systems and methods for mapping volumes using shape sensing optical fibers in applications for evaluating internal cavities or the like.

In many applications, it is often necessary to understand the features and geometry of internal cavities. This information may not be easily accessible by imaging modalities or may not be easily digitized for use with software programs or analysis tools. In many instances, it is important to know the geometry of an internal cavity or be able to digitally map the internal cavity.

In accordance with the present principles, a system, device and method include a sensing enabled device having at least one optical fiber configured to sense induced strain within the device. An interpretation module is configured to receive signals from the at least one optical fiber interacting with a volume and to interpret the signals to determine positions visited by the at least one optical fiber within the volume. A storage device is configured to store a history of the positions visited in the volume.

A system includes a sensing enabled device having at least one optical fiber configured to sense induced strain in the device. An index-based voxel coordinate lookup table is stored in memory where indexed bins, corresponding to positions in a volume to be mapped, store a likelihood measure as a history of a number of visits to corresponding positions by the at least one optical fiber. An interpretation module is configured to receive signals from the at least one optical fiber interacting with the volume and to interpret the signals to determine visited positions by the at least one optical fiber within the volume. A display is configured to render a map of the visited positions in the volume.

A method for mapping a volume includes initializing memory locations corresponding to positions in a volume; acquiring a data set of visited positions in the volume by exploring the volume with a fiber optic shape sensing enabled device; recording the visited positions of the fiber optic shape sensing device by updating memory locations corresponding to the positions visited; and mapping measures related to the volume based on the positions visited.

These and other objects, features and advantages of the present disclosure will become apparent from the following detailed description of illustrative embodiments thereof, which is to be read in connection with the accompanying drawings.

This disclosure will present in detail the following description of preferred embodiments with reference to the following figures wherein:

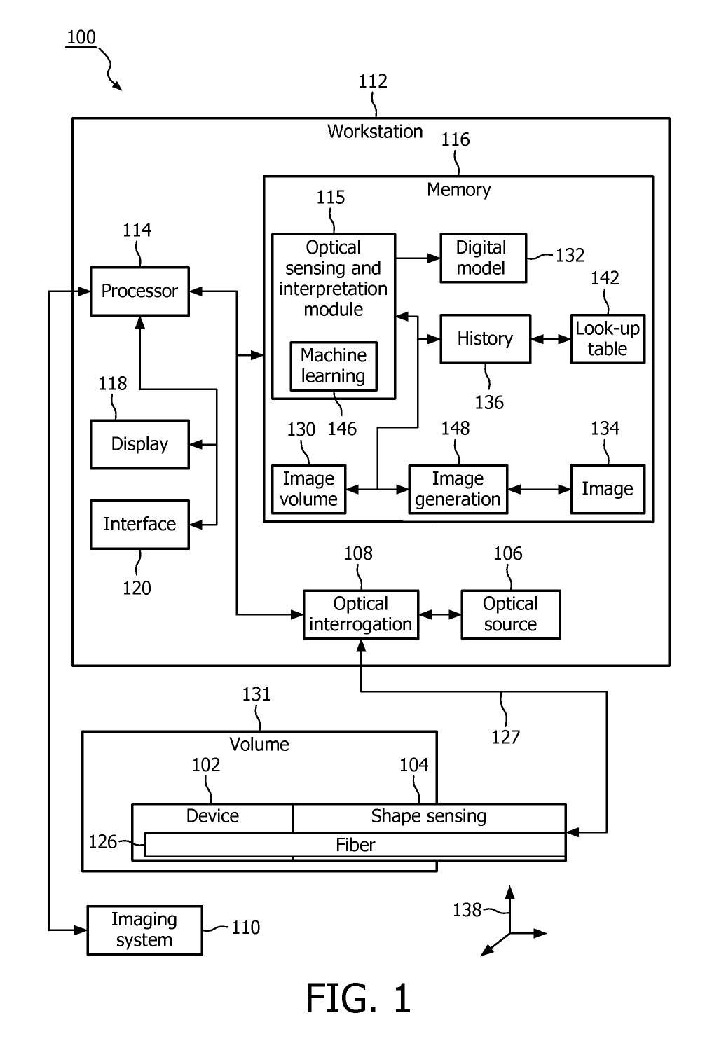

FIG. 1 is a block/flow diagram showing a system and workstation with a shape sensing enabled system for mapping a volume in accordance with one embodiment;

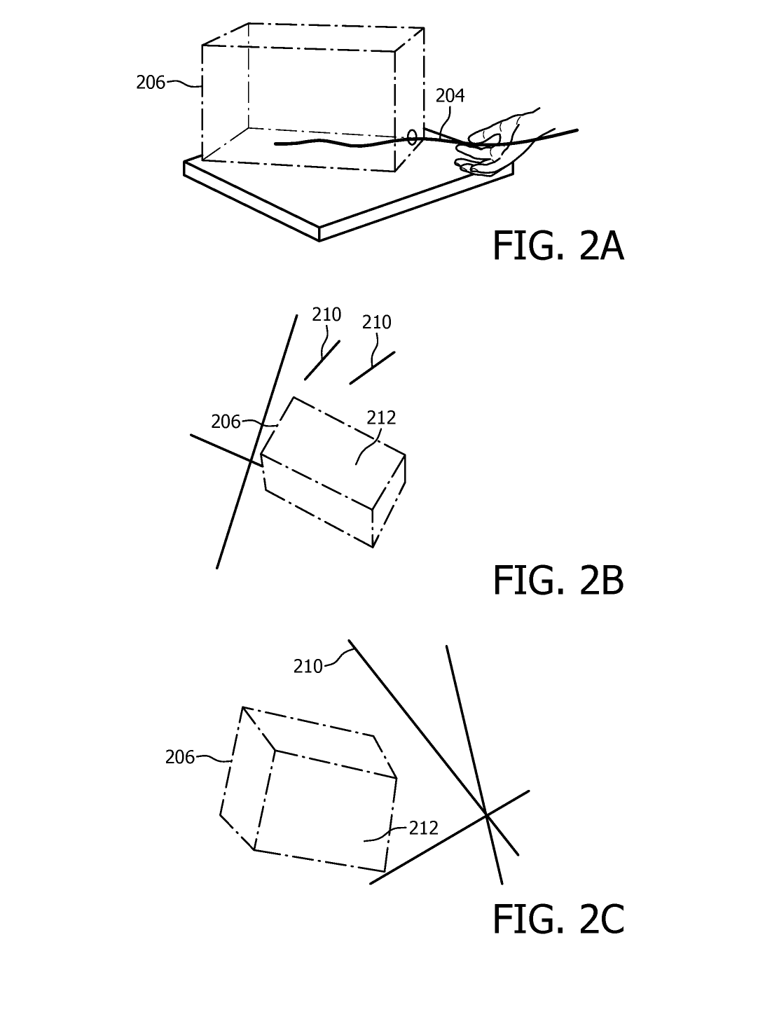

FIG. 2A is an image showing an experimental setup for mapping out a box in accordance with the present principles;

FIG. 2B is an image showing traces of visited positions by a fiber optic device in the experimental setup of FIG. 1 in accordance with the present principles;

FIG. 2C is another image showing traces of visited positions by the fiber optic device in the experimental setup of FIG. 1 in accordance with the present principles;

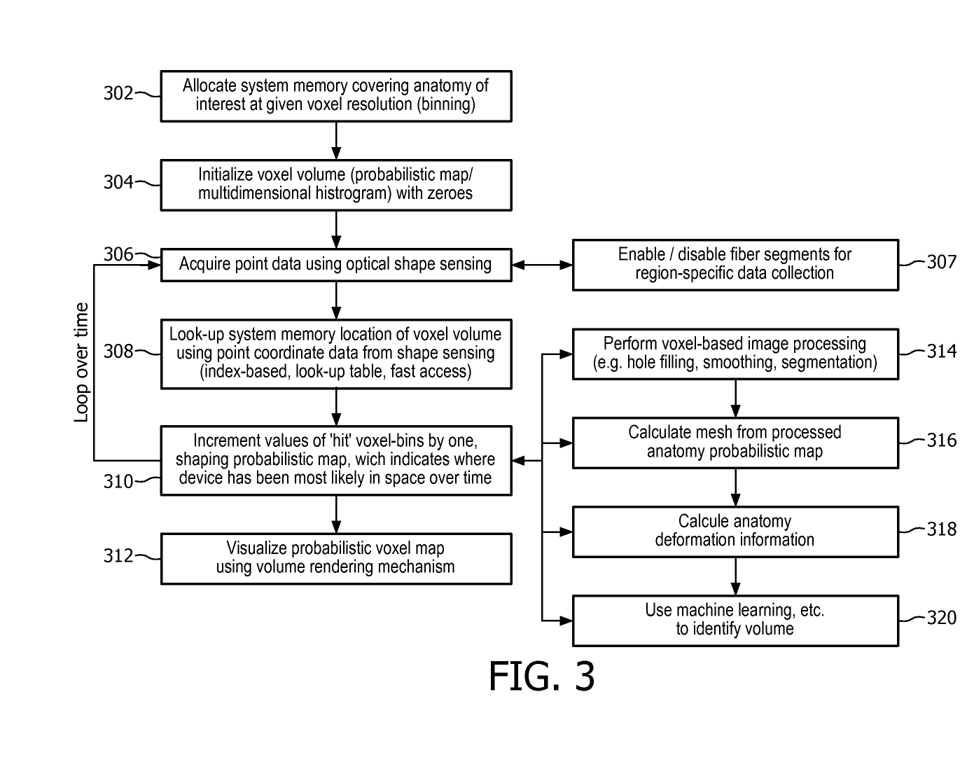

FIG. 3 is a block/flow diagram showing a system/method for gathering and employing sensed strain data for mapping out a volume in accordance with another illustrative embodiment; and

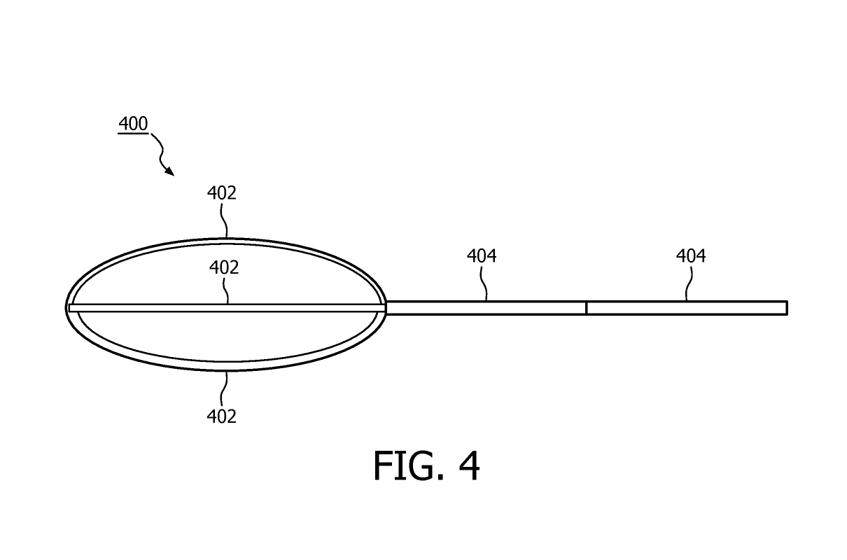

FIG. 4 is a diagram showing an illustrative shape sensing configuration having separated and longitudinal segments in accordance with another illustrative embodiment.

In accordance with the present principles, systems and methods are provided which employ fiber optic shape sensing and localization technology to deliver accurate reconstructions of shapes. Accurate shape data may be retrieved by “painting” a structure of interest with a fiber optic shape sensing enabled instrument (e.g., a catheter or the like at the time of an interventional procedure).

In one embodiment, shape data in the form of ultra-dense point clouds can be acquired using fiber optic shape sensing and localization technology. Point-based mesh processing algorithms may be inappropriate given the high data rate of fiber optic shape sensing and localization technology and the complex topology of anatomical structures.

A system is employed which permits mapping of ultra-dense point cloud data into a voxel data set using an index-based look-up mechanism. The voxel data may be processed using, e.g., standard image processing techniques (e.g., de-noising, hole filling, region growing, segmentation, meshing) and/or visualized using volume rendering techniques. The voxel data set can represent a probabilistic map where every voxel indicates a likelihood that the shape sensing enabled device (e.g., a medical device) was present over time and space. The system also permits immediate visualization of shapes and interrogated structures such as chambers or cavities.

Shape sensing based on fiber optics is preferably employed to use inherent backscatter properties of optical fiber. A principle involved makes use of distributed strain measurement in the optical fiber using characteristic Rayleigh backscatter patterns or other reflective features. A fiber optic strain sensing device is mounted on or integrated in a medical instrument or other probing device such that the fiber optic sensing device can map a spatial volume. In one embodiment, space is defined by a reference coordinate system. The space is then occupied by the sensing device, which by its presence senses the open space and its boundaries within the space. This information can be employed to compute the features of the space, the size of the space, etc.

In one illustrative embodiment, a system performs distributed fiber optic sensing to digitally reconstruct a space or volume. The strain measurements are employed to resolve positions along a length of the sensing device to determine specific locations along the sensing device where free space is available to occupy. The sensing device is moved within the space to test the boundaries of the space. As data is collected over time, a three-dimensional volume is defined by accumulated data.

It should be understood that the present invention will be described in terms of medical instruments; however, the teachings of the present invention are much broader and are applicable to other instruments. In some embodiments, the present principles are employed in tracking or analyzing complex biological or mechanical systems (e.g., plumbing systems or the like). For example, a cavity within a building wall or within an engine block may be mapped out using the present principles. In particular, the present principles are applicable to internal tracking or mapping procedures of biological systems, procedures in all areas of the body such as the lungs, gastro-intestinal tract, excretory organs, blood vessels, etc. The elements depicted in the FIGS. may be implemented in various combinations of hardware and software and provide functions which may be combined in a single element or multiple elements.

The functions of the various elements shown in the FIGS. can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), non-volatile storage, etc.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams and the like represent various processes which may be substantially represented in computer readable storage media and so executed by a computer or processor, whether or not such computer or processor is explicitly shown.

Furthermore, embodiments of the present invention can take the form of a computer program product accessible from a computer-usable or computer-readable storage medium providing program code for use by or in connection with a computer or any instruction execution system. For the purposes of this description, a computer-usable or computer readable storage medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W), Blu-Ray™ and DVD.

Referring now to the drawings in which like numerals represent the same or similar elements and initially to FIG. 1, a system 100 for mapping volumes is illustratively shown in accordance with one embodiment. System 100 may be employed with, and is applicable for, all applications for interventional and surgical procedures that employ fiber optic shape sensing. In addition the present principles may be applied to mechanical systems, such as mapping out a cylinder in an engine block, searching a cavity of an antiquity, a space in an architectural setting, etc. Distributed fiber optic sensing of strain may be employed to reconstruct the shape and/or features of a cavity, and/or reconstruct or digitize an interior or exterior surface. By employing the optical fiber over regions of a shape, a data cloud of the shape features can be learned and employed to digitize the shape.

For a medical application, a medical instrument 102 may be equipped with a shape sensing device 104. The shape sensing device 104 on the medical device 102 may be inserted into a volume 131 (e.g., a cavity inside a body). Reflective properties of received light from illuminated optical fibers of the shape sensing device 104 indicate strain measurements which may be interpreted to define a space of the shape sensing device 104. The shape of the shape sensing device 104 is set in a coordinate system 138 to enable the definition of points relative to each other in the space.

System 100 may include a workstation or console 112 from which a procedure is supervised and/or managed. Workstation 112 preferably includes one or more processors 114 and memory 116 for storing programs and applications. Memory 116 may store an optical sensing and interpretation module 115 configured to interpret optical feedback signals from the shape sensing device or system 104. Optical sensing module 115 may be configured to use the optical signal feedback (and any other feedback, e.g., electromagnetic (EM) tracking, etc.) to reconstruct deformations, deflections and other changes associated with a medical device or instrument 102 and/or its surrounding region. The medical device 102 may include a catheter, a guidewire, a probe, an endoscope, a robot, an electrode, a filter device, a balloon device, or other medical component, etc. It should be understood that the shape sensing device 104 may be employed with or independently from the medical device 102.

The sensing system includes an optical interrogator 108 that provides selected signals and receives optical responses. An optical source 106 may be provided as part of the interrogator 108 or as a separate unit for providing light signals to the sensing device 104. Sensing device 104 includes one or more optical fibers 126 which may be coupled to the device 102 in a set pattern or patterns. The optical fibers 126 connect to the workstation 112 through cabling 127. The cabling 127 may include fiber optics, electrical connections, other instrumentation, etc., as needed.

Sensing device 104 with fiber optics may be based on fiber optic Bragg grating sensors. A fiber optic Bragg grating (FBG) is a short segment of optical fiber that reflects particular wavelengths of light and transmits all others. This is achieved by adding a periodic variation of the refractive index in the fiber core, which generates a wavelength-specific dielectric mirror. A fiber Bragg grating can therefore be used as an inline optical filter to block certain wavelengths, or as a wavelength-specific reflector.

A fundamental principle behind the operation of a fiber Bragg grating is Fresnel reflection at each of the interfaces where the refractive index is changing. For some wavelengths, the reflected light of the various periods is in phase so that constructive interference exists for reflection and, consequently, destructive interference for transmission. The Bragg wavelength is sensitive to strain as well as to temperature. This means that Bragg gratings can be used as sensing elements in fiber optical sensors. In an FBG sensor, the measurand (e.g., temperature or strain) causes a shift in the Bragg wavelength.

One advantage of this technique is that various sensor elements can be distributed over the length of a fiber. Incorporating three or more cores with various sensors (gauges) along the length of a fiber that is embedded in a structure permits a three dimensional form of such a structure to be precisely determined, typically with better than 1 mm accuracy. Along the length of the fiber, at various positions, a multitude of FBG sensors can be located (e.g., 3 or more fiber sensing cores). From the strain measurement of each FBG, the curvature of the structure can be inferred at that position. From the multitude of measured positions, the total three-dimensional form is determined and temperature differences can be determined.

As an alternative to fiber-optic Bragg gratings, the inherent backscatter in conventional optical fiber can be exploited. One such approach is to use Rayleigh scatter in standard single-mode communications fiber. Rayleigh scatter occurs as a result of random fluctuations of the index of refraction in the fiber core. These random fluctuations can be modeled as a Bragg grating with a random variation of amplitude and phase along the grating length. By using this effect in three or more cores running within a single length of multi-core fiber, the 3D shape, temperature and dynamics of the surface of interest can be followed. Other reflective/scatter phenomena may also be employed.

An imaging system 110 may be employed for in-situ imaging of a subject or volume 131 during a procedure. Imaging system 110 may include a fluoroscopy system, a computed tomography (CT) system, an ultrasonic system, etc. The imaging system 110 may be incorporated with the device 102 (e.g., intravenous ultrasound (IVUS), etc.) or may be employed externally to the volume 131. Imaging system 110 may also be employed for collecting and processing pre-operative images (e.g., image volume 130) to map out a region of interest in the subject to create an image volume for registration with shape sensing space. It should be understood that the data from imaging device 110 may be helpful but is not necessary for performing a mapping in accordance with the present principles. Imaging device 110 may provide a reference position as to where a cavity or other region of interest exists within a body but may not provide all the information that is desired or provide a digitized rendition of the space or be capable of resolving all of the internal features of the space.

In one embodiment, workstation 112 includes an image generation module 148 configured to receive feedback from the shape sensing device 104 and record accumulated position data as to where the sensing device 104 has been within the volume 131. An image 134 of the history of the shape sensing device 104 within the space or volume 131 can be displayed on a display device 118. Workstation 112 includes the display 118 for viewing internal images of a subject (patient) or volume 131 and may include the image 134 as an overlay or other rendering of the history of visited positions of the sensing device 104. Display 118 may also permit a user to interact with the workstation 112 and its components and functions, or any other element within the system 100. This is further facilitated by an interface 120 which may include a keyboard, mouse, a joystick, a haptic device, or any other peripheral or control to permit user feedback from and interaction with the workstation 112.

In another embodiment, system 100 includes a method or program 136 to compute the history of the shape sensing device 104 within the volume 131 without employing any other imaging or tracking scheme or relying on any outside technology or user observation/intervention. The system 100 computes the points of the shape sensing device 104 dynamically in real-time and knowing coordinate positions of all points along a length of the sensing device 104 within the space 131. The coordinate system 138 is established for the shape sensing device 104 by defining a reference position and then determining distance from that position. This may be done in a number of ways including but not limited to establishing an initial position of the shape sensing device as a reference, employing an image volume 130 and registering the shape sensing space with the image volume 130, etc.

The history of the shape sensing device 104 within the volume 131 may be stored in an index-based voxel coordinate lookup table 142, which stores information or frequency of visits of the shape sensing device 104. The look-up table 142 includes memory locations or bins associated with positions in the volume 131. Each time the shape sensing enabled device 104 enters a position the look-up table 142 is incremented at that corresponding bin. The binned data may be interpreted or used in many ways. For example, the interpretation module 115 may include a machine learning method 146 or other program or method to identify the volume based upon stored information or history of the shape sensing device 104. The history may be analyzed over time using the interpretation module 115 to compute a deformation of the volume (e.g., due to motion, heartbeats, breathing, etc.) or a derived measure over time (e.g., growth rates, swelling, etc.). The interpretation module 115 may also employ the date to compute a digital model 132 of the volume. This model 132 may be employed for other analysis or study.

The shape sensing device 104 is able to deliver accurate reconstructions of shapes of the space 131. Four-dimensional (3D+time) shapes of, e.g., a 1.5 m tether/fiber can illustratively be reconstructed at a frame rate of, e.g., about 20 Hz providing 30,000 data points every 50 ms, spaced at 50 micrometer increments along a fiber. This acquisition and reconstruction process results in a data rate of, e.g., about 10 Mbyte/s or roughly 80 Mbit/s which needs to be transferred, for example, over a network or other connection, processed and visualized. Accurate shape data permits a “painting” or mapping of an anatomy of interest (e.g., the walls of space 131). The data rates and memory are illustrative and are system dependent.

Referring to FIGS. 2A-2C, an illustrative example of volume rendering with probabilistic voxel maps of dense point cloud data acquired using fiber optic shape sensing and localization is illustratively shown. In FIG. 2A, a box 202 has been interrogated using a shape sensing enabled catheter 204. The box 202 represents an enclosed volume. Data was collected for positions of the sensing device 204. The data is displayed in FIGS. 2B and 2C. For the data visualized in FIGS. 2B and 2C, the shape sensing device 204 was maneuvered within the box 202 outlined by dashed lines 206. In FIGS. 2B and 2C, the shape of the box 202 is well represented. The data shows locations where the sensing device 204 remained for longer time by hyperintense traces (brighter lines), e.g., at a physical hole enabling entrance to the box 202. Regions where the sensing device 204 occupied the space for short periods of time are hypointense traces (darker lines). The data in FIGS. 2B and 2C shows stray lines 210 which may be due to glitches in reconstruction limitations of the shape sensing device 204 and may be filtered out.

Shape data in the form of ultra-dense point cloud(s) 212 can be easily acquired using the shape sensing technology. In one embodiment, point-based mesh processing algorithms (e.g., convex hull) may be employed, although given the high data rate of fiber optic sensing and the complex topology of anatomical structures, such as, cardiovascular chambers with branching structures, which are poorly defined by standard convex hull algorithms (e.g. left atrium and pulmonary veins), other modeling systems may be more appropriate. These modeling systems may make use of the cloud of data points to model the volume for further analysis or imaging.

In one embodiment, the ultra-dense data point cloud 212 may be mapped into a voxel data set using an index-based look-up mechanism. The voxel data set can be processed using image processing techniques (e.g., de-noising, hole filling, region growing, segmentation, meshing) and/or visualized using volume rendering techniques. The voxel data set represents essentially a probabilistic map where every voxel indicates the likelihood that the medical device (e.g., shape sensing enabled device) was present over time and space. The system permits immediate visualization of shapes and interrogated structures such as chambers.

Referring to FIG. 3, a system/method for generating probabilistic maps using fiber optic shape sensing data is illustratively shown. In block 302, given a shape sensing enabled device such as a catheter, a user needs to define a location and dimensions of a field-of-view (FOV). In case of a 1.5 m fiber, the FOV can be at a maximum of, e.g., 3×3×3 m³. Given the exquisite accuracy of the shape sensing system of about 1 mm at 1 m fiber length, one may want to set the voxel dimensions for volume binning to say 2 mm. This would result in a volume size of (1500)³ voxels needing about 13 Gbytes memory (using a 4 byte data type). In practice, however, the anatomy of interest is most probably a much smaller volume, say about 300 mm³ resulting in about 13 Mbytes memory requirements. Once the system memory is allocated, the memory is initialized with zeroes at each bin location in block 304. The voxel volume pixels will represent a probabilistic map or multi-dimensional histogram of visited space.

In block 306, the shape sensing device is introduced to a volume to be mapped. The shape sensing device is articulated in the volume in a random way although a patterned articulation method may also be employed. The goal is to cover as much of the volume with the shape sensing device as possible preferably in a short amount of time. In some embodiments, the boundaries of the volume should be swept with a higher frequency to assist in defining the volume or objects/features contained therein.

In block 307, an automated or user interactive approach can be used for selection of fiber segments or sub-segments of interest that will be used for the voxelization process. This may include selecting a sub-region for data collection or employing multiple sensing segments and selecting a set of segments for data collection. The fiber sensing device may include a plurality of coaxially disposed segments or longitudinal segments to sweep the volume more efficiently. This can, for example, be used to ensure that voxel measurements are generated only for all or a portion of the fiber segments falling within a sub-region of interest within the overall working volume. The sub-regions can be user-selectable or automatically specified from within a volume rendering. The sub-regions can also be defined by other visualizations of pre-procedural imaging data, “live” intraprocedural images or from a library of similar studies which permit expert system guidance for fiber optic shape sensing configurations during an intervention.

In block 308, the shape sensing data frames from the shape sensing system may be mapped into the volume using an index-based voxel coordinate lookup, e.g.:

$${x}_{voxel , i} = [ \frac{{x}_{fiber , i} - {x}_{0}}{dx} ] , \\ {y}_{voxel , i} = [ \frac{{y}_{fiber , i} - {y}_{0}}{dy} ] , \\ {z}_{voxel , i} = [ \frac{{z}_{fiber , i} - {z}_{0}}{dz} ] , \\ {index}_{i} = {x}_{voxel , i} + {y}_{voxel , i} * sx + {z}_{voxel , i} * sx * sy$$

where x_{voxel,i} corresponds to the index of the voxel x-coordinate interrogated with the fiber optic shape sensing device along fiber index position i (x_{fiber,i}), x₀ is the x-offset of the voxel volume given the coordinate system origin of the shape sensing device and dx is the voxel resolution along the x-axis in mm. indexᵢ is the index look-up position within the voxel data set given a linear data array at fiber index position i. The same holds for each of the y and z directions. sx is the voxel grid size along the x-dimension (for sy along the y-direction). If the index is negative or larger than the array size, the shape sensing measurement is outside the FOV. Other indexing schemes may also be employed.

In block 310, once the index position within the voxel volume is calculated, the voxel value is incremented by one (or set to any other desired value/modification by any other operation) when the shape sensing device is determined to be in the corresponding indexed position thereby creating a probabilistic map. This indicates where the shape sensing device was physically present in space and for how much time. The process may be looped over time, returning to block 306 for new positions of the shape sensing device. Note that the voxel access has to be repeated for each measurement point along the fiber at the acquisition frame rate, e.g., 20 Hz (e.g., downsampling fiber element size to say about 1 mm can dramatically increase speed).

In block 312, a resulting voxel map can be visualized using volume rendering, multiplanar reformatting (MPR), maximum intensity projection (MIP), or surface rendering (e.g., isosurface visualization) methods to name a few. The voxelized shape sensed data permits rendering of only the most likely areas where the device was present. This could be, for example, a heart chamber. The shape of the heart chamber would be hyperintense in the volume rendering for most dominant cardiac and breathing phases.

In block 314, voxel-based image processing may be performed on the data set. This may include modifying color-maps, opacity/translucency look up tables, etc. The voxel data set can be processed using image processing techniques (e.g., de-noising, hole filling, region growing, segmentation, meshing) and/or visualized using volume rendering techniques. In another embodiment, encoding of other information such as electrical potentials measured at corresponding fiber optic shape sensing node locations may be considered. Such data can be encoded in the voxel data set, using, for example, Red Green Blue Alpha (RGBA) or other data types for volume rendering. In block 316, the voxel-based data set may be employed to compute a mesh or other computational model, which may be employed to perform finite element analysis or other analysis.

In block 318, voxelized shape sensing data combined or not combined with other sensor data may be employed to identify and compensate for volume motion (e.g., heart chamber motion). Using the shape sensing data over time, an estimate of the shape/motion of the volume can be estimated. A further embodiment includes functional imaging while interrogating for extended time periods (e.g., hyperintense regions with little movement have a higher likelihood that the shape sensing device is present, and hypointense fast moving regions have less likelihood that the device is/was present). In this way, mechanical dyssynchrony can be estimated comparing the intensity of the point cloud voxel images along different regions of say the left ventricle. Cardiac output can be estimated by comparing hypointense regions corresponding to the region of moving myocardium and the hyperintense regions corresponding to the main body of the cavity. Other applications are also contemplated.

In block 320, voxelized point cloud images can be coupled with machine learning algorithms or other data processing algorithms to automate identification of anatomical targets of interest, delineate target regions, modify imaging system or interventional system settings to optimize diagnostic or therapeutic efficacy.

Referring to FIG. 4, an illustrative fiber optic enabled shape sensing device 400 is shown in accordance with another embodiment. Device 400 may include separated segments 402 each carrying one or more optical fibers. Device 400 may include longitudinal segments 404 where a predetermined portion or segment 404 is employed to map out a volume as described above. While the shape sensing enabled device need not include any segments, the device 400 in this embodiment may include separated segments 402, longitudinal segments 404 or both. The segments 402 or 404 may be enabled for shape sensing using the interpretation module 115 (FIG. 1) to sense characteristic features for that segment and become sensitized to interpret feedback from that segment or segments.

Having different configurations of segments may promote faster data collection from a volume being mapped. For example, fingers or separated segments 402 may be configured to fit in tight spaces within the volume. The shape sensing devices may have customized configurations designed to improve accuracy and/or data collection.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function; and
e) no specific sequence of acts is intended to be required unless specifically indicated.

Having described preferred embodiments for rapid dense point cloud imaging using probabilistic voxel maps (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the embodiments disclosed herein as outlined by the appended claims. Having thus described the details and particularity required by the patent laws, what is claimed and desired protected by Letters Patent is set forth in the appended claims.

1. A system, comprising:
a sensing enabled device having at least one optical fiber configured to sense induced strain within the device;
an interpretation module configured to receive signals from the at least one optical fiber interacting with a volume and to interpret the signals to determine positions visited by the at least one optical fiber within the volume; and
a storage device configured to store a history of a frequency of the positions visited in the volume.

2. The system as recited in claim 1, wherein the storage device stores bins corresponding to positions in the volume and the history includes a count of the frequency of visits to the corresponding positions.

3. The system as recited in claim 1, wherein the shape sensing enabled device is included in a medical device and the volume includes an internal cavity in a body.

4. The system as recited in claim 1, wherein the interpretation module includes a machine learning method employed to identify the volume based upon stored information.

5. The system as recited in claim 1, wherein the sensing enabled device includes selectively enabled segments such that a portion of the segments are enabled to map out the volume.

6. The system as recited in claim 1, wherein the history includes deformation information for the volume and the interpretation module is configured to compute a deformation of the volume or a derived measure over time.

7. The system as recited in claim 1, wherein and the interpretation module is configured to compute a digital model of the volume.

8. The system as recited in claim 1, wherein the history includes using an index-based voxel coordinate lookup table.

9. A system, comprising:
a sensing enabled device having at least one optical fiber configured to sense induced strain in the device;
an index-based voxel coordinate lookup table stored in memory where indexed bins, corresponding to positions in a volume to be mapped, store a likelihood measure as a history of a frequency of visits to corresponding positions by the at least one optical fiber;
an interpretation module configured to receive signals from the at least one optical fiber interacting with the volume and to interpret the signals to determine visited positions by the at least one optical fiber within the volume; and
a display configured to render a map of the visited positions in the volume.

10. (canceled)

11. (canceled)

12. (canceled)

13. (canceled)

14. (canceled)

15. The system as recited in claim 9, wherein the display is configured to render a map of derived quantitative measures computed from the likelihood map.

16. A method for mapping a volume, comprising:
initializing memory locations corresponding to positions in a volume;
acquiring a data set of visited positions in the volume by exploring the volume with a fiber optic shape sensing enabled device;
recording a frequency of the visited positions of the fiber optic shape sensing device by updating memory locations corresponding to the positions visited; and mapping measures related to the volume based on the positions visited.

17. The method as recited in claim 16, wherein recording the visited positions includes storing the frequency as counts in indexed bins corresponding to positions in the volume.

18. (canceled)

19. The method as recited in claim 16, further comprising identifying the volume based upon on the positions visited using a machine learning method.

20. (canceled)

21. The method as recited in claim 16, wherein updating memory locations corresponding to the positions visited includes storing deformation information for the volume to compute movement of the volume over time.

22. (canceled)

23. The method as recited in claim 16, wherein mapping measures related to the volume based on the positions visited includes mapping computed region statistics or other measures.
